(19) United States
(12) Patent Application Publication
(10) Pub. No.: US 2002/0090054 A1
(43) Pub. Date: Jul. 11, 2002

(54) Apparatus and method for containing debris from laser plasma radiation sources

(76) Inventor: Michael Sogard, Menlo Park, CA (US)

Correspondence Address: David Hill Esq, Finnegan Henderson Farabow Garrett & Dunner LLP, 1300 I Street N W, Suite 700, Washington, DC, 20005-3315, US

(21) Appl. No.: 09/756,909

(22) Filed: Jan. 10, 2001

(51) Int. Cl. H01J 35/00

(52) U.S. Cl. 378/119; 378/143

(57) ABSTRACT

A debris containment shutter useable in a photolithography system comprises one or more moving members that sweep and/or deflect debris that is associated with plasma generated from a target away from the structures to be protected from the debris. The members may be configured as a structure that moves across the plasma space in which the debris populates, such as a rotating or reciprocating structure. For controlling debris associated with pulsed radiation, the movement of the members is synchronized with the pulses of plasma emitted radiation. In one aspect of the present invention, the shutter comprises a plate rotatable about an axis of rotation, the plate defining at least one opening therethrough and at least one member (e.g., in the form of baffles or vanes) extending from a surface of the plate. The members may extend radially outward from a hub or inward from a perimeter. In another aspect of the invention, the shutter includes a manifold which extends at least partially around the perimeter of the members. The manifold preferably defines a volume for collection of debris from a space traversed by the member when the plate is rotated.

### FIELD OF THE INVENTION

This invention relates generally to a method and apparatus for containing debris and more particularly to a method and apparatus for containing debris from laser plasma radiation sources in an X-ray or extreme ultraviolet (“EUV”) exposure system.

### BACKGROUND OF THE INVENTION

Certain types of lithography and microscopy utilize EUV or X-ray radiation as the radiation source. For example, a lithography system may utilize EUV or X-ray radiation to expose resist covered semiconductor wafers. The resist covered semiconductor wafers are placed in the path of the radiation emanating from a patterned mask and are exposed thereby. When the resist is developed, the mask pattern is transferred onto the wafer. In microscopy extreme ultra violet (EUV) or X-ray radiation is transmitted through a thin specimen to a resist covered plate. When the resist is developed, a topographic shape is left which is related to the specimen structure.

An important source of X-ray or EUV radiation is high temperature plasmas generated by focusing intense pulses of laser light on a target. The target may be a solid, liquid or gaseous material. The spectral properties of the radiation generated are a function of the target composition and structure and the laser pulse properties such as wavelength, peak irradiance, pulse length, and laser spot size.

One significant drawback of the X-ray or EUV lithography system is that the laser induced plasma, in addition to creating X-rays or EUV radiation, also creates material and ion debris as a result of the high temperatures achieved in the plasma. The solid or liquid target material within the focused spot of the laser is quickly vaporized and a relatively low temperature ionized plasma is initially created. The plasma is then heated to very high temperatures by the remaining laser pulse. The debris emerge from the target at relatively high velocities and relatively high temperatures. The debris include ions, atoms and clusters of atoms, some of macroscopic size, which, at high velocities and temperatures, can damage and/or impair nearby optical and/or other components. Over time the debris can coat optical surfaces, changing their reflective or transmissive properties. The problems caused by debris have presented long standing complications to the use of solid or liquid target sources. Thus, it would be desirable to provide a method of containing the debris generated from solid or liquid target sources in order to alleviate or avoid such damage.

These problems associated with the debris generated by laser induced plasmas present serious restrictions on the use of solid or liquid radiation sources or targets which would otherwise be advantageous for some certain applications. A number of approaches have been proposed or utilized to reduce the detrimental effects of debris.

One way to attempt to overcome the debris problem is to use a gaseous source which generates a relatively small amount of debris. However, atoms of high kinetic energy are generated which over time can also inflict damage to the nearby optical and/or other components. Such atoms of high kinetic energy may be retarded or stopped by providing a relatively low pressure gas surrounding the target. Alternatively or additionally, a very thin window having absorption properties compatible with the desired spectral properties of the radiation may be provided in the X-ray path.

Further, in order for the laser pulse to be efficiently absorbed by the gaseous target, the gas source density must be high. Providing a high density gas requires the use of complex and sophisticated supersonic nozzle and pump. In addition, the density of the gaseous source drops very rapidly as the gas moves away from the nozzle and expands. Thus, the laser pulse must focus at a location close to the nozzle. As a result, some material from the nozzle is often eroded by the plasma, leading to another source of debris.

Another disadvantage in using a gaseous source as the target is the high cost associated with the gas itself. As an example, xenon, a gas which can be used as the target, is fairly expensive.

Another approach to reduce debris is to provide a liquid aerosol target. Some liquids may be used as low-debris targets if the liquid source can be dispersed into a fog of very fine droplets. Ideally, each fine droplet is completely consumed by the laser pulse. However, a liquid aerosol target may not be completely consumed by the laser pulse, possibly leading to debris generation. Again, a very thin window having absorption properties compatible with the desired spectral properties of the radiation may be provided to prevent debris from damaging optical and/or other components.

As noted, a very thin window having absorption properties compatible with the desired spectral properties of the radiation may be provided in a system utilizing a gaseous or liquid source. However, the use of such a window is limited in practice for several reasons. The window must have a relatively high transparency to the desired radiation. Otherwise, the window would greatly decrease the system efficiency. For EUV radiation, for example, the transparency requirement may dictate an extremely thin and therefore fragile window. Such a window can be easily damaged by debris, or the window can become coated with debris over time which would change its optical properties and reduce transmission and system efficiency as well as result in frequent replacement of the window. In addition, while a low pressure ambient gas can reduce the speed of the fast atoms, the atoms can diffuse to other parts of the system and eventually coat their surfaces, possibly changing their optical and/or other properties.

Nevertheless, gaseous and liquid sources produce far less debris than solid targets. For example, the amount of debris generated by using a gaseous or liquid source is presently within an order of magnitude of satisfying the requirements for an EUV radiation source for EUV lithography. Solid targets are currently considered to generate far more debris than is acceptable for such applications. Exclusion of solid targets seriously restricts the elemental composition of the target. This in turn may restrict the available spectral properties and the efficiency of conversion from laser light to the radiation.

A mechanical reciprocating or rotating shutter is a conventional technique for the containment of debris. The conventional shutter opens for the laser pulse and the plasma generated radiation but closes before the fastest debris reach its plane. However, the shutter merely captures the fastest debris particles from passing beyond the shutter plane. Slower debris particles can pass through the shutter once it reopens for a subsequent laser shot. High pulse repetition rate lasers, being considered for EUV radiation plasma sources, exacerbate this problem. Thus, a rotating shutter does not completely or effectively prevent the debris from damaging optical and/or other components.

An example of a rotating shutter is described in U.S. Pat. No. 4,408,338 entitled “Pulsed Electromagnetic Radiation Source Having a Barrier for Discharged Debris” to Grobman, which is incorporated herein in its entirety. Grobman describes a rotating shutter located in the path of an electromagnetic radiation source. The shutter is positioned sufficiently far from the source of the electromagnetic radiation that an emitted pulse of electromagnetic radiation and the debris simultaneously discharged with the pulse become spatially separated and arrive at the shutter at different times due to inherent propagation speed difference. The shutter is essentially a circular plate with a single aperture or notch. The movement of the shutter is synchronized with the electromagnetic pulse such that the electromagnetic pulse encounters an open shutter while the faster traveling debris encounters a closed shutter. However, as noted above, the rotating shutter disclosed by Grobman does not contain or capture the slower moving debris which has not yet reached the shutter when the shutter reopens for the next electromagnetic pulse.

As is evident, while a conventional shutter can be designed to stop the fastest debris emanating from the target, the shutter cannot stop all of the debris, because the emitted debris have a broad spectrum of velocities. Some of the debris desirably strike the closed shutter. However, other, slower debris will generally still be in motion when the shutter reopens for the next laser pulse and a fraction of those debris will pass through the opening. Thus, a significant leakage of debris may result. Since it is the larger debris particles which are generally at a slower velocity, the shutter may have little effect in limiting damage to the components of the laser plasma system and/or other nearby sensitive equipment.

Another example of a method for reducing debris is described in U.S. Pat. No. 4,860,328 entitled “Target Positioning For Minimum Debris” to Frankel et al., the entirety of which is incorporated herein by reference. Frankel et al. disclose a target used to generate an X-ray emitting plasma in a lithographic system. The target is designed to minimize debris resulting from the plasma. However, Frankel et al. do not disclose a mechanism to contain the debris which are nevertheless generated.

It is thus desirable to provide an effective apparatus for containment of debris from a laser plasma source to a level acceptable for EUV lithography. It is also desirable to allow the use of solid, liquid/aerosol or gaseous sources for radiation generation to meet the low debris requirements for EUV lithography and/or other applications. Such a system would desirably provide a much larger selection of target materials, resulting in a much larger variety of spectral characteristics and generation efficiencies for the radiation. It is further desirable to provide a simple and cost-effective debris containment system and method which is not significantly affected over time by the debris which are at a high energy and can coat the surrounding surfaces. Such a system would thus desirably require less down time for a lithography system.

### SUMMARY OF THE INVENTION

The present invention provides a debris containment shutter that comprises one or more moving members that sweep and/or deflect debris that is associated with plasma generated from a target away from the structures to be protected from the debris. The members may be configured as a structure that moves across a region in proximity to the target thereby intercepting debris from the plasma, such as a rotating or reciprocating structure. For controlling debris associated with pulsed radiation, the movement of the members is synchronized with the pulses of plasma emitted radiation.

In one embodiment of the present invention, the shutter comprises a plate rotatable about an axis of rotation, the plate defining at least one opening therethrough and at least one member (e.g., in the form of baffles or vanes) extending from a surface of the plate. Each member is disposed adjacent to each of the at least one opening and is radially disposed relative to the axis of rotation. The opening allows the passage or transmission of plasma emitted radiation (e.g., X-rays) therethrough when the shutter is open. The members facilitate containing the debris generated when laser beams focus upon a target to form radiation emitting plasma.

In one aspect of the present invention, a rotatable shutter has a plurality and equal number of openings and members, the openings and members being circumferentially and alternately disposed about the axis of rotation.

In another aspect of the invention, the shutter includes a manifold which extends at least partially around the perimeter of the members and the plate. The manifold preferably defines a volume for collection of debris from a space traversed by the member when the plate is rotated. The manifold is preferably circular and defines an opening in the circumferential direction to allow the passage of laser beams to the target for generating X-ray emitting plasmas. The shutter may comprise one or more covers extending at least partially across the plate at a distance from the plate. The cover may be on a side of the plate opposite the members and/or on the same side of the plate as the members. The shutter may also extend outward to contain debris to protect the optical system for generating laser beams. The plate may provide another set of openings to allow the pulses of laser beams to pass therethrough. The members may also extend radially to further contain the debris.

Each member may be in the shape of linear or curvilinear vanes and/or form of a plurality of angled blades. Where the shutter provides vanes comprising multiple angled blades, the shutter may further provide stationary stator blades at least partially intermeshed with the angled blades of the vanes.

The present invention desirably reduces the debris from a laser plasma source to a level acceptable for EUV lithography. It is compatible with high repetition rate lasers contemplated for such uses. It is vacuum compatible and may permit the use of gaseous, aerosol type liquid or solid targets or sources while meeting the low debris requirements for EUV lithography. The present invention allows the laboratory use of laser plasmas from solid targets with little or no damage to ancillary equipment.

These and other objects, features, and advantages of the invention will become readily apparent to those skilled in the art upon a study of the drawings and a reading of the description of the invention provided below.

### BRIEF DESCRIPTION OF THE DRAWINGS

FIG. 1 shows a plane view of the debris containment shutter in accordance with one embodiment of the present invention;

FIG. 2 shows a cross-sectional side view along line 2-2 of the debris containment shutter of FIG. 1;

FIG. 3 shows a plane view of a debris containment shutter of the present invention having curvilinear vanes;

FIG. 4 shows a cross-sectional side view along line 4-4 of the debris containment shutter of FIG. 3;

FIG. 5 shows a plane view of a debris containment shutter providing a large solid angle in accordance with another embodiment of the present invention;

FIG. 6 shows a cross-sectional view along line 6-6 of one of the vanes of the debris containment shutter of FIG. 5;

FIG. 7 shows a cross-sectional side view along line 7-7 of the debris containment shutter of FIG. 5;

FIG. 8 shows the geometry used in a model calculation of the efficiency of a turbomolecular pump;

FIG. 9 shows the transmission probability calculated for a single stage turbomolecular pump;

FIG. 10 shows the vane embodied in FIGS. 5, 6, and 7 as a variation of the blade geometry in a turbomolecular pump;

FIG. 11 shows a plane view of a debris containment shutter of the present invention having stator vanes;

FIG. 12 shows a cross-sectional view along line 12-12 of the debris containment shutter of FIG. 11;

FIG. 13 shows a cross-sectional view along line 13-13 of the debris containment shutter of FIG. 11;

FIG. 14 shows a linearly reciprocating shutter of the present invention.

FIG. 15 shows a plane view of a dual debris containment shutter providing a larger solid angle.

FIG. 16 shows a cross sectional side view along line 16-16 of the debris containment shutter of FIG. 15.

FIG. 17 shows a cross sectional side view along line 17-17 of the debris containment shutter of FIG. 15.

FIG. 18 shows a plane view of a dual debris containment shutter utilizing rotors and stators to provide a larger solid angle.

FIG. 19 shows a cross sectional side view along line 19-19 of the debris containment shutter of FIG. 18.

FIG. 20 shows a cross sectional side view along line 20-20 of the debris containment shutter of FIG. 18.

FIG. 21 shows a cross sectional side view along line 21-21 of the debris containment shutter of FIG. 18.

FIG. 22 shows the cover plate 622 of the debris containment shutter of FIG. 18.

FIG. 23 shows a plane view of a debris containment shutter with rotors curved around the target to provide a larger solid angle.

FIG. 24 shows a cross sectional side view along line 24-24 of the debris containment shutter of FIG. 23.

FIG. 25 shows a cross sectional side view along line 25-25 of the debris containment shutter of FIG. 23.

FIG. 26 shows a plane view of the debris containment shutter of FIG. 23 with a tape target.

FIG. 27 shows a cross sectional side view along line 27-27 of the debris containment shutter with the tape target shown in FIG. 26.

FIG. 28 shows a magnified view of part of the tape target circled in FIG. 27.

FIG. 29 shows a plane view of the debris containment shutter of FIG. 23 with a gas or liquid target.

FIG. 30 shows a cross sectional side view along line 30-30 of the debris containment shutter with the gas or liquid target shown in FIG. 29.

FIG. 31 is a simplified partial side view of an example of a lithography system in which the apparatus and method of the present invention for containing debris may be implemented.

### DESCRIPTION OF THE ILLUSTRATED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

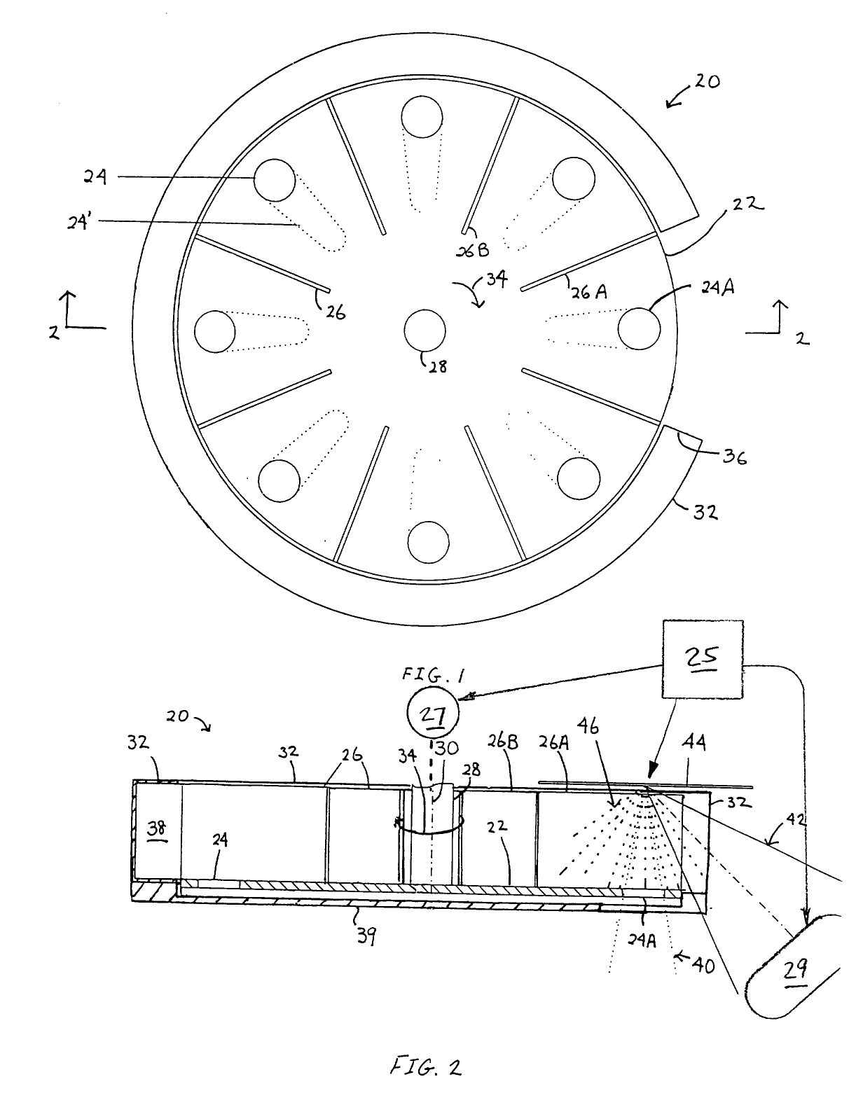

FIGS. 1 and 2 show, respectively, a plane view and a cross-sectional view along line 2-2 of a debris containing shutter 20 in accordance with one embodiment of the present invention. The shutter 20 generally comprises a plate or disc 22 defining apertures or openings 24 therethrough, members in the form of vanes 26 preferably in contact with a surface of the plate 22, a shaft 28 on which the plate is mounted allowing the plate to rotate about an axis of rotation 30, and a manifold 32.

As shown in FIG. 2, to generate X-rays 40, laser beam 42 is focused on a laser plasma target or source 44 to generate X-ray emitting plasmas. Debris is also generated when the X-ray emitting plasmas are generated. When rotated about the axis of rotation 30, debris containing shutter 20 selectively and periodically opens and closes. When the shutter 20 is open, the shutter 20 allows the passage or transmission of, for example, X-rays and debris therethrough. Similarly, when the shutter is closed, the shutter 20 prevents the passage of, for example, X-rays and debris therethrough. The shutter 20 is considered closed when it blocks passage of both debris and x-rays within the solid angle defined by the optics; or other area which would normally receive the x-rays.

Each opening 24 allows the passage or transmission of X-rays 40 through the shutter 20 when the opening is located in the path of the X-rays (and debris), such as opening 24A. Preferably, at any given time, only one opening 24 is located in the path of the X-rays while the other openings 24 are not located in the path of the X-rays. However, depending upon the placement of the openings 24 and vanes 26 relative to each other and to the plate 22, one or two additional openings 24 adjacent and downstream and/or upstream of the opening 24A may also be in the path of the X-rays and debris.

The size and shape of the openings 24 affects the solid angle of the shutter system and thus the amount and geometry of the transmitted X-rays 40. Openings 24 are preferably circular as shown in FIG. 1 because many optical systems are based on axial symmetry. However, openings 24 may be of any suitable size and/or shape, depending upon the particular application and/or the angular distribution of the X-rays 40. Examples of alternative shapes of openings 24 include a rectangle, a trapezoid, an ellipse or a part of a sector 24′, as shown in phantom in FIG. 1. The larger sectorial openings 24′ provide the shutter system 20 with a larger solid angle, allowing the passage or transmission of a greater amount of X-rays 40. For example, treating FIGS. 1 and 2 as scale drawings, the solid angle associated with the circular openings 24 is approximately 0.12 steradian. For the sectorial openings 24′ the solid angle is 0.28 steradian.

When the plate 22 is rotated about the axis of rotation 30 in the direction 34, the shutter 20 opens as opening 24A is positioned in the path of the X-rays 40 and debris 46. A control system 25 is connected to a motor 27 which drives the shutter 20 and to a laser beam pulse generator 29. The control system 25 controls and synchronizes the rotation of the shutter 20 and the timing of the laser beam pulses such that the shutter 20 opens simultaneously with the generation of X-ray emitting plasma by focusing a pulse of laser beam 42 on the target 44. The control system 25 may also control the target, e.g., moving it in order to expose fresh material to the laser, as the plasma erodes it away.

As the plate 22 continues to rotate to close the shutter 20, the vane 26A adjacent and downstream of the opening 24A traverses a volume of space. The space traversed by the vane 26A contains the paths of the X-rays 40 and debris 46 generated by the previous pulse of focused laser beam 42. Preferably, the plasma generated by the previous pulse of focused laser beam 42 has quenched long before the vane 26A passes the site or space.

When the vane 26A traverses through the X-ray space, the vane 26A sweeps the space and contacts at least a portion of the debris contained in that space. The portion of the debris in the X-ray space contacted by the vane 26A can be and is preferably significant. Only the slowest debris contained in the region between a surface of the target 44 facing the shutter 22 and a surface of the vane 26A facing the target 22 is not contacted by the vane 26A. The debris 44 contained in the remainder of the X-ray space is thus either deposited onto or deflected by a surface of the vane 26A facing the X-ray space. The slowest debris is either deposited onto or deflected by a surface of the subsequent vane 26B which traverses the X-ray space after the next pulse of laser beam, and into which the slowest debris drifts in the time between the arrival of vanes 26A and 26B.

The vane 26A transfers a relatively large momentum to the debris 44 deflected by and not deposited onto the vane 26A. The large momentum results from the high rotational speed of the plate 22. Preferably, the plate 22 rotates at a speed such that the vanes 26 are moving at a velocity comparable to or greater than the velocity of the debris. The debris velocity will have a broad spectrum with a peak velocity (depending on plasma conditions) perhaps as high as 10⁴ cm/sec, according to a paper by M. C. Richardson et al in Applied Optics 32, 6901(1993) (this is to be compared to the speed of light that the x-rays propagate at 3×10¹⁰ cm/sec). The momentum transferred to the debris 46 by the vane 26A is in general not well defined. For small particles, on the atomic or molecular scale, the particles reflect from the vane surface in a diffuse manner, leading to a Lambert, or cosine, distribution in reflection angle, and a loss of correlation between the incident and final directions. It is difficult to predict therefore whether the vane itself can effectively expel the small debris particles from the X-ray space without the assistance of the plate 22. For larger debris particles however, the momentum transferred to the debris 46 by the vane 26A is in the direction in which the vane 26A is moving. In other words, the momentum transferred to the debris 46 is in a direction generally perpendicular to the vane 26A at the point of deflection or in a direction generally tangential to the circumference of the plate 22. Thus, the deflected debris 46 is expelled out of the X-ray space in a direction tangential to the circumference of the plate into the manifold 32.

As is evident, the remainder of the openings 24 and vanes 26 operate in a similar manner as described above for opening 24A and vane 26A. Preferably, the rotation of the plate 22 is such that the frequency of the opening of the shutter 20 is correlated with and synchronized to the frequency of the pulses of the laser beam 42. In general, the shutter needs to be open only long enough for X-rays to pass through the opening. Further, the shutter 22 preferably closes before the fastest debris 46 reaches the plate 22.

The vanes 26 extend from a surface of the plate 22 by being in contact with, attached to, or integral with the plate 22. Each vane 26 may be a flat plate. Further, as shown in FIG. 1, each of the vanes 26 is preferably extending equidistantly in a radial direction relative to the axis of rotation 30. In addition, each of the vanes 26 is preferably equidistantly disposed relative to each other in a circumferential direction of the plate 22. The openings 24 and the vanes 26 are preferably alternately disposed. Although eight openings 24 and eight vanes 26 are shown in the shutter 20 of FIG. 1, any suitable number of openings and vanes may be provided. The number, size, shape and positioning of the openings and vanes as well as the plate may depend upon many of the various operating parameters such as the desired solid angle and the requirements of the optical system for generating the pulses of laser beams.

As an example, the plate may be approximately 150 mm in diameter with eight openings and eight vanes, and spaced 10 mm from the laser focal plane. Each opening is circular with a diameter of approximately 8.5 mm, yielding a solid angle for the x-rays of 0.5 steradian. The vanes are preferably about 40 mm in length, 9 mm in height and 1 mm or less in width. The frequency of the opening of the shutter and the frequency of the laser beam pulses are equal and may be approximately 1500 Hz. The plate then rotates at a frequency of 11,250 rpm, and its peripheral velocity is approximately 90 m/sec.

In order to maximize the available solid angle, it is desirable to keep the distance between the laser target plane and the plane of the shutter or other plate defining the opening for the x-rays as small as possible. However the distance must be great enough that the shutter can close before the most rapid debris reaches the shutter plane. In the above example, assuming the most rapid debris velocity to be 10⁴ cm/sec, the shutter must close within 1 cm/10⁴ cm/sec=10⁻⁴ sec. Since the shutter opening is 8.5 mm=0.85 cm, the velocity of the shutter must exceed 0.85 cm/10⁻⁴ sec=85 m/sec, which is less than the velocity specified above. Therefore the distance between the laser target plane and the plane of the shutter could be reduced somewhat, thereby increasing the solid angle, without impairing shutter performance.

Clearly, if the shutter speed could be increased, the distance between the laser target plane and the plane of the shutter could be reduced further, and the solid angle could be further increased (the angular spacing of the openings would be increased to maintain synchronism with the laser pulse rate). The upper limit of a rotational shutter speed can be shown to be related to the tensile strength S and the density ρ of the shutter material as maximum rotational speed ∝(S/ρ)^{½}. This is well understood in ultracentrifuge technology. The above rotational speeds are well within the limits of common metals.

Many variations may be made to the configuration of the openings 24 and vanes of the shutter 22. For example, fewer or more vanes and openings may be provided. The vanes may be disposed immediately adjacent each opening such that there are twice as many vanes as openings and the vanes are not circumferentially equidistant relative to each other.

In another variation, the vanes 26 may extend radially inward to the shaft 28. However, even if the debris 46 does reach the region between the vanes 26 and the shaft 28, such debris 46 is generally stopped by the plate 22, as there are no openings in that region of the plate. Thus, it is not particularly beneficial to extend the vanes into this region. In addition, it is preferable to have some distance between the vanes 26 and the shaft 28 such that if there is ambient gas in the system, such as a low pressure gas, the rotational resistance caused by the vanes is not so high as to unduly affect the rotational speed of the shutter 22 and/or the power consumption of the shutter motor.

Some of the debris may stick to the vanes 26 or the plate 22. This will improve the performance of the shutter in preventing the escape of debris. However, over time, the buildup of material from the target on the vanes 26 or the plate 22 may create an asymmetric mass distribution, which can lead to rotational instability of the rotator, which would then have to be replaced. It may be possible to treat the surface of vanes 26 and plate 22, so as to reduce this debris buildup. Such treatment would depend on the elemental composition of the laser target 44.

A manifold or collection channel 32 partially surrounds plate 22 and vanes 26 and defines an annular space 38 for the collection of debris 46. The debris 46 contained by the vanes 26 is preferably collected by the annular space 38. The manifold 32 is stationary and provides an opening or gap 36 which allows the laser beam 42 to pass through the gap 36 and focus on the target 44. Although the opening or gap 36 of the manifold 32 may be of any suitable size, FIG. 1 shows that the opening or gap 36 of the manifold 32 approximates the circumferential distance between two adjacent vanes 26.

The shutter 20 may be operated in a low ambient pressure or low pressure chamber and preferably a supply of low pressure gas is continuously fed through the chamber. The low pressure ambient gas slows down fast atoms of the debris 46, which may have velocities too high for the shutter 20 to contain. The low pressure ambient gas also causes the debris 46 deflected from the vanes 26 to diffuse.

The supply of low pressure gas may be exhausted through the manifold 32 such that the debris 46 collected by the manifold 32 may be removed by the flow of low pressure gas. Alternatively or additionally, a vacuum pump may be connected to the manifold 32 to provide a slight vacuum in the manifold 32 relative to the ambient chamber pressure. The pressure differential between the manifold 32 and the ambient chamber causes the debris 46 collected by the vanes 26 to be actively drawn into manifold 32 and removed from the manifold 32.

A cover 39 may be provided on a side of the plate 22 opposite the target 44 and the vanes 26. The cover 39 may generally extend over the plate 22 except for an area adjacent the gap 36 of the manifold 32 through which the X-rays may pass. The cover 39 is a distance from the plate 22 such that the cover 39 does not interfere with the rotation of the plate 22. The cover 39 is also stationary and may be supported by the manifold 32 as shown in FIG. 2. Alternatively, the cover 39 may be supported by some other stationary element (not shown). The cover 39 further contains the debris 46, which may pass through the plate 22 via one of the openings 24, when the opening is generally disposed over the cover 39. In addition, in the event of a breakage or imbalance of a component of the shutter 22, the cover 39 serves to prevent additional damage to nearby components, such as sensitive optical components.

Plate 22 is shown to be circular having a central axis of rotation 30. Although such a configuration is preferred, however, as will be understood by one of ordinary skill in the art, the shutter plate may be configured in a different shape. However, the plate should be rotationally balanced to avoid imparting torque to the shaft 28. Instead of rotational movement, the plate may be configured to reciprocate in a linear motion without departing from the scope and meaning of the present invention. FIG. 14 schematically shows such a configuration, in which a rectangular shutter plate 60 is driven to reciprocate across the path of the plasma emitted radiation 40. An aperture 62 is provided to allow passage of the emitted radiation 40 through the plate 60. The plate has a cutout 64 through which the incident laser beam 42 can pass through. Baffles 66 extending from the plate 60 sweep and/or deflect debris 46 from the plasma space as the plate 60 moves to cover the plasma space to prevent the debris 46 from passing through the aperture 62 and the cutout 64. The debris containment function and mechanics are similar to the previous embodiment. A manifold (not shown) may be provided at the edge of the plate 60.

It is noted that the shutter plate 60 may be of other shapes, depending on the coverage area desired. The shutter plate 60 may be configured to reciprocate in an arc, in which case the baffles 66 may be configured radially with reference to the center of the arc (not shown).

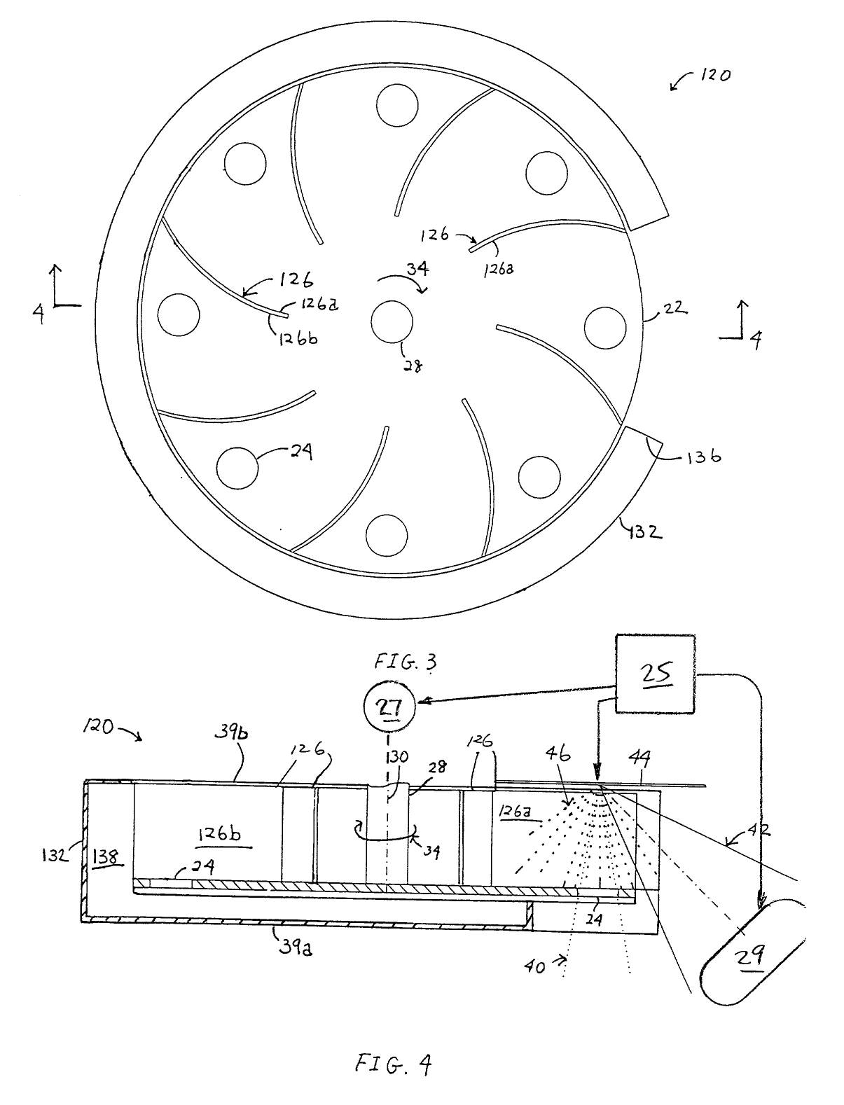

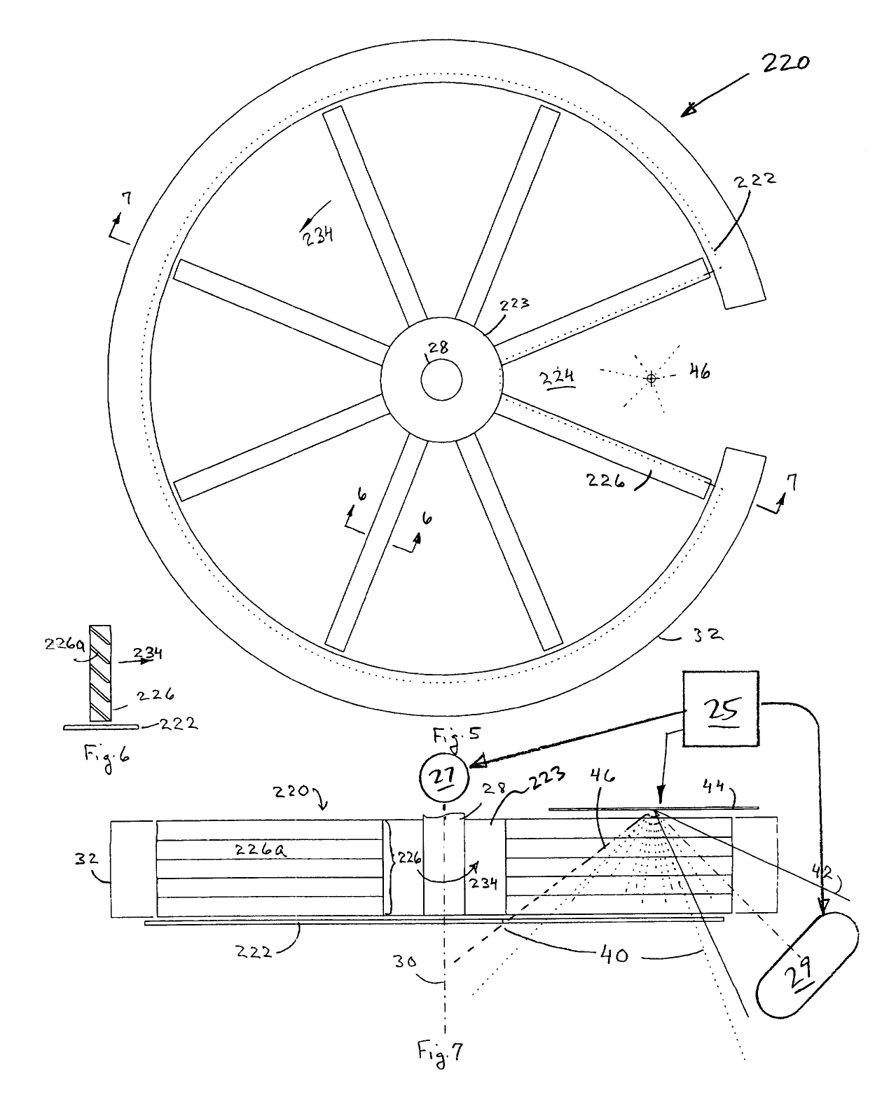

FIGS. 3 and 4 show, respectively, a plane view and a cross-sectional view along line 4-4 of another debris containing shutter 120. Similar to the debris containing shutter shown in FIGS. 1 and 2, the debris containing shutter 120 generally comprises a plate or disc 22 defining apertures or openings 24 therethrough, vanes or members 126 extending from a surface of the plate 22, a shaft 28 on which the plate 22 is mounted allowing the plate 22 to rotate about an axis of rotation 30, and a manifold 32. As is evident, the same reference numerals are utilized to designate similar elements. Further, only the elements that are different from those already discussed above will be described below.

As shown in the plane view of FIG. 3, each vane 126 extends curvilinearly in a radial direction relative to the axis of rotation 30 such that vanes 126 function as impeller vanes. Each curvilinear vane 126 thus has a concave surface 126a and a convex surface 126b. Preferably, the plate 22 of shutter 120 is rotated in direction as indicated by arrow such that the concave surfaces 126a of the vanes 126 generally face the direction of rotation 34. Although not shown, each vane 126 may also be angled relative to the axis of rotation 30.

The curvilinear or impeller vanes 126 are particular suited for use in a low pressure ambient gas. In particular, the curvilinear shape of the vanes 126 facilitates the driving of the low pressure ambient gas as well as the debris particles which diffused in the low pressure ambient gas outwardly in a radial direction into the collection manifold 132.

Also shown in FIGS. 3 and 4, the collection manifold 132 similar to the collection manifold 32 shown in FIGS. 1 and 2 partially surrounds plate 22 and vanes 126 and defines a space 138 for the collection of debris 46. The annular space 138 is disposed to collect debris 46 contained by the vanes 126.

The stationary collection manifold 132 also includes a covering portion 39a, which extends to a side of the plate 22 opposite the target 44 and the vanes 126. The covering portion 39a is disposed a small distance from the plate 22 such that it does not interfere with the rotation of the plate 22. As is evident, the covering portion 39a of manifold 132 is integral with the remainder of the manifold 132 and thus may remove the debris 46 collected therein by, for example, a flow of low pressure gas.

The covering portion 39a of the manifold 132 may generally extend over the plate except for an open region 136 of the manifold 132. As is evident, the covering portion of the manifold 132 is similar to and serves a similar function as the cover 39 shown in FIG. 2. The open region 136 of the manifold 132 allows the laser beam 42 to pass through the open region 136 and focus on the target 44 as well as allows the X-rays 40 to pass through the shutter 120 via the open region 136.

A cover 39b may also be provided on a same side of the plate 22 as the target 44 and the vanes 126. The cover 39b is disposed a small distance from the plate 22 such that the cover 39b does not interfere with the rotation of the plate 22. The cover 39b may generally extend over the plate 22 except for an area adjacent the target 44 mechanism (not shown).

The cover 39b is stationary and may be supported by the manifold 132. Alternatively, as with cover portion 39a of the manifold 132, the cover 39b may be integral with manifold 132 such that any debris 46 collected by cover 39b may be removed via the manifold. The cover 39b further contains debris 46 which may be deflected in a direction away from plate 22.

Further, the cover 39b may improve the driving of the low pressure ambient gas as well as the debris particles which diffused in the low pressure ambient gas in a radial direction into the collection manifold 132. In particular, the cover 39b may limit the volume of low pressure ambient gas which is available for driving into the manifold 132 by the curvilinear vanes 126, and thus creating a pressure which is lower than the ambient pressure inside the shutter 120. In addition, in the event of a breakage or imbalance of a component of the shutter 20, the cover 39b serves to prevent additional damage to any nearby components, such as the target mechanism and/or sensitive optical components.

In the above embodiments of the shutter, because of the rotational speed required of these shutters, these shutters are most suitable for radiation collection optics with relatively small solid angles. However, certain applications may require larger solid angles, for example, 1 steradian or above.

FIGS. 5-7 show, respectively, a plane view and cross-sectional views along lines 6-6 and 7-7 of another debris containing shutter 220 which provides larger solid angles. The shutter 220 generally provides solid angles in the range of 0.5 to perhaps more than 1.5 steradian. Interpreting FIGS. 5-7 as scale drawings, the embodiment provides a solid angle of 1.33 steradian.

Similar to the debris containing shutter 20 shown in FIGS. 1 and 2 and the debris containing shutter 120 shown in FIGS. 3 and 4, the debris containing shutter 220 generally comprises a stationary plate or disc 222 defining an aperture or opening 224 therethrough, vanes or members 226 extending from a hub 223, a shaft 28 on which the hub 223 is mounted to allow the vanes to rotate about an axis of rotation 30, and a manifold 32. Again, the same reference numerals are utilized to designate similar elements and only the elements that are different from those already discussed above will be described below.

As is represented by the dotted line 222 in FIG. 5, the opening 224 of the shutter 220 generally extends from the central hub 223 to the border of the plate 222 as well as the edges of each of the two vanes adjacent the opening. Thus, the size of the openings 224 is approximately at a maximum. Unlike the aperture plate 22 of the earlier embodiments, the plate 222 does not rotate with the vanes. Consequently, it has just a single opening 224 for the radiation. It thus combines the functions of the aperture plate and the cover plate 39 of the earlier embodiments.

The solid angles of the previous embodiments are limited by the plate 22, which plays an essential role in stopping and diverting debris. The vanes serve to sweep out debris that could diffuse through holes in the plate subsequent to the creation of the debris. In the new embodiment, the vanes are designed to remove all the debris without the assistance of the plate 22.

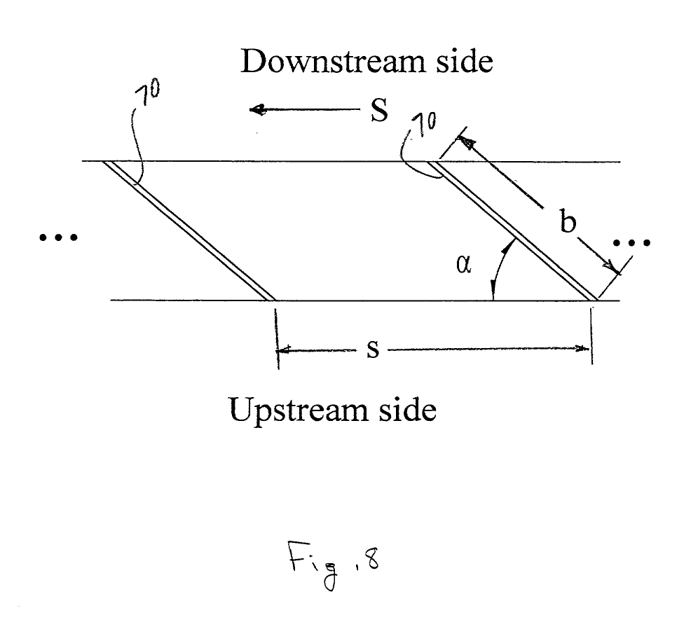

Each of the vanes or radial arms 226 comprises a plurality of blades 226a at an angle relative to both the plane defined by the plate 222 and to the axis of rotation 30. Thus, any debris impacted by the blades 226a of the vanes 226 either coats the blades 226a or is preferentially deflected by the blades 226a in a direction toward the target 44 (away from the plane defined by the plate 222) and/or radially outward toward the manifold 32. With the orientation of the blades 226a shown in FIG. 6, the shutter is preferably rotated in a direction 234 to achieve such deflection toward the target 44. Similar to the above-described embodiments of the shutter, the rotational speed of the shutter 220 is such that the vanes 226 are at a higher velocity than the debris 46.

The blades 226a of the vanes 226 are similar in function as those found in a conventional turbomolecular pump. U.S. Pat. No. 4,787,829 entitled “Turbomolecular Pump” to Miyazaki et al., U.S. Pat. No. 5,350,275 entitled “Turbomolecular Pump Having Vanes With Ceramic and Metallic Surfaces” to Ishimaru, and U.S. Pat. No. 5,688,106 entitled “Turbomolecular Pump” to Cerruti et al. describe various examples of turbomolecular pumps and are incorporated by reference in their entireties herein.

The operation of this embodiment may be understood with guidance from the theory of the axial flow turbomolecular pump, as described in e.g. “The axial flow compressor in the free molecular range” by C. Kruger and A. Shapiro (Proceedings of the 2nd International Symposium on Rarefied Gas Dynamics, L. Talbot, ed., Academic Press, NY, 1961, p117), which is fully incorporated by reference herein. It is noted that the three-dimensional flow analysis is rather complex, and the following discussion of the flow theory does not address all the complexities involved in a three-dimensional flow. The analysis below is intended to provide a possible explanation for the operations of the present invention. The theory is applied here based on the assumption that the debris particles can be regarded as being in the molecular flow regime, even if a low pressure ambient gas is present. The debris density is low enough that collisions between debris particles is unlikely, and if the debris particles are heavy enough that collisions with the ambient gas doesn't alter their velocity substantially in the times between collisions with the vanes, molecular flow can be assumed. The assumption of a Maxwellian velocity distribution is also assumed, even though in theory the debris velocity distribution does not obey a Maxwellian distribution. However, both experimental and theoretical results suggest that the basic results are not too sensitive to this assumption.

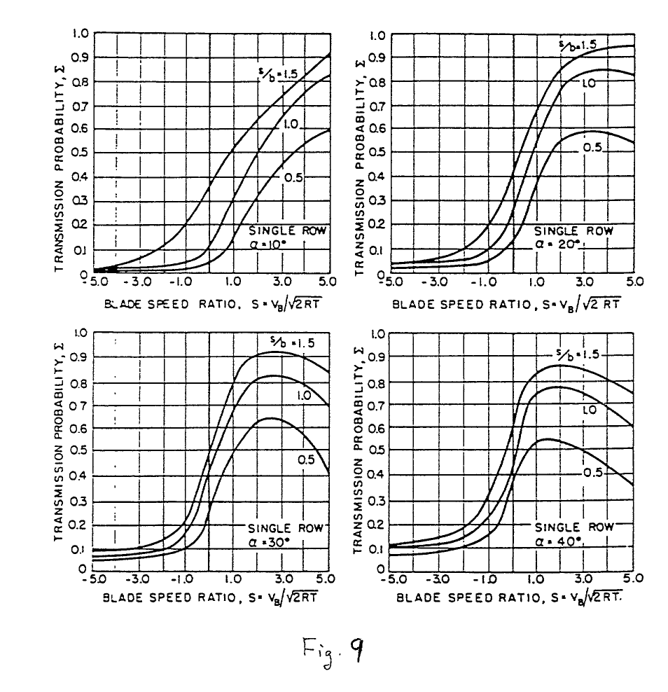

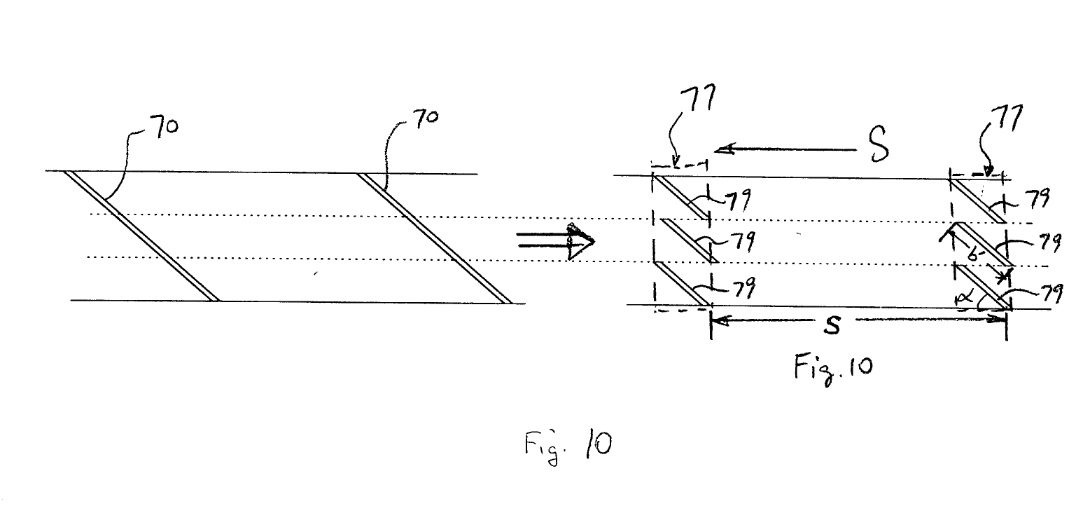

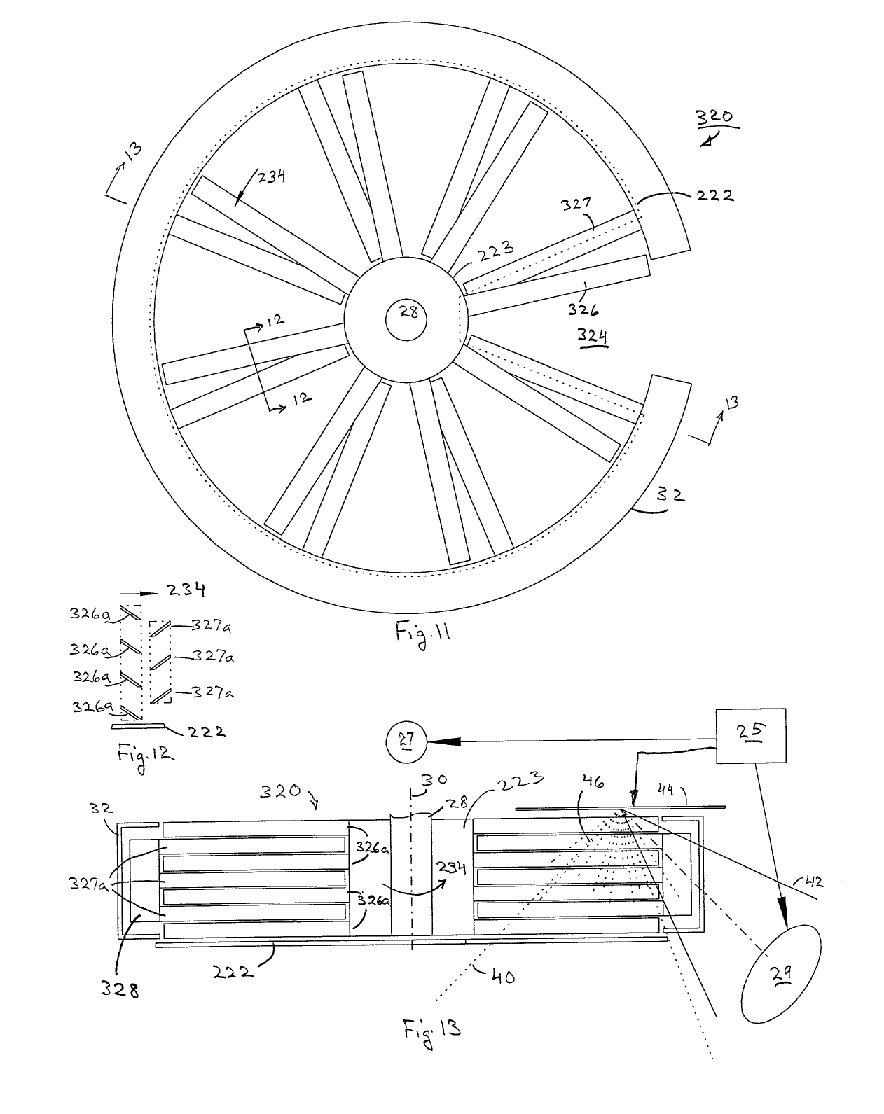

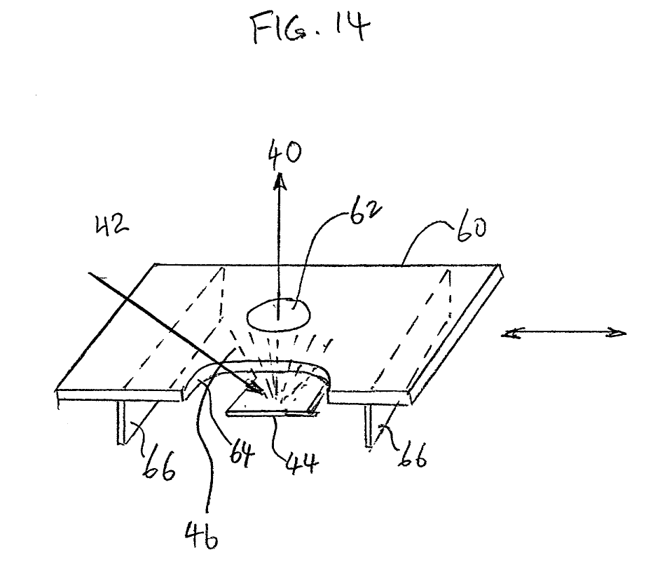

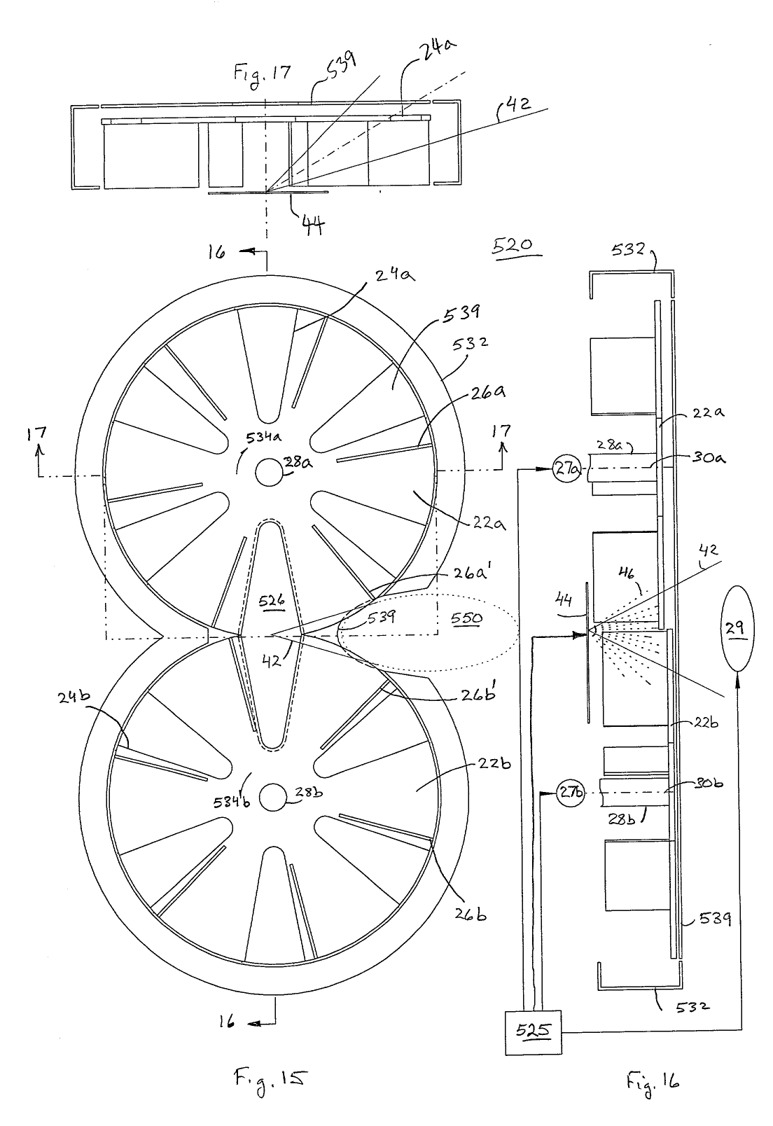

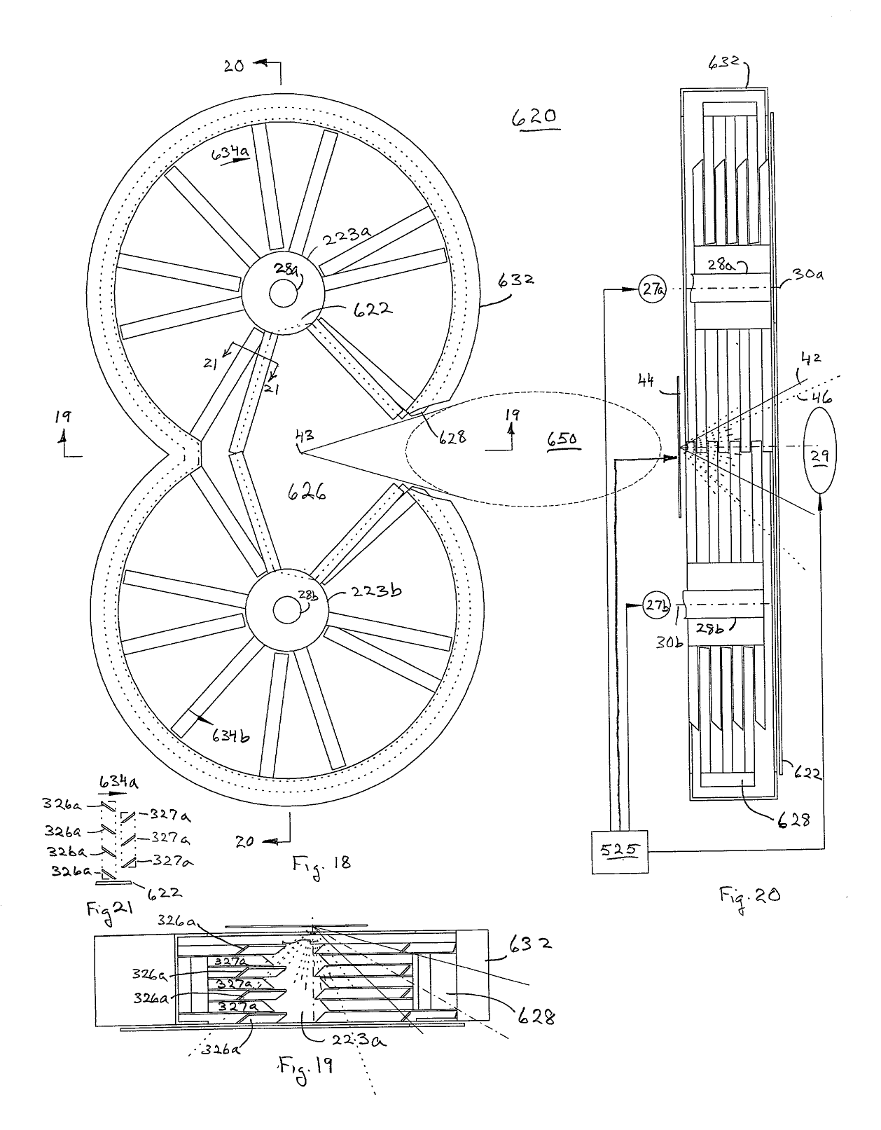

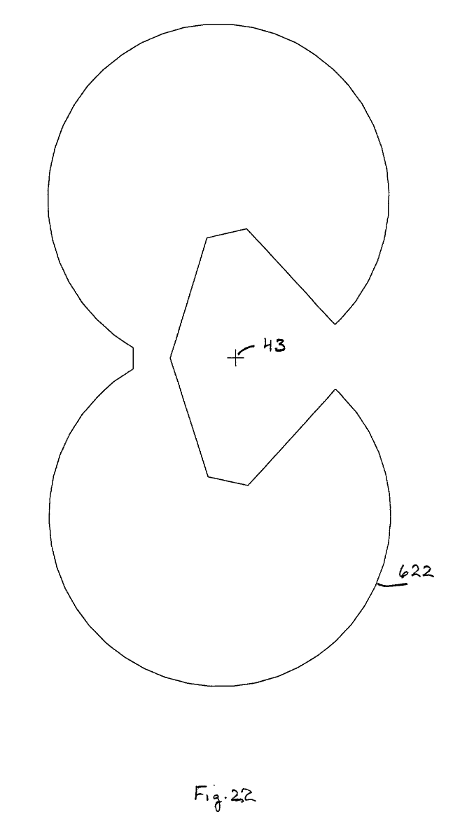

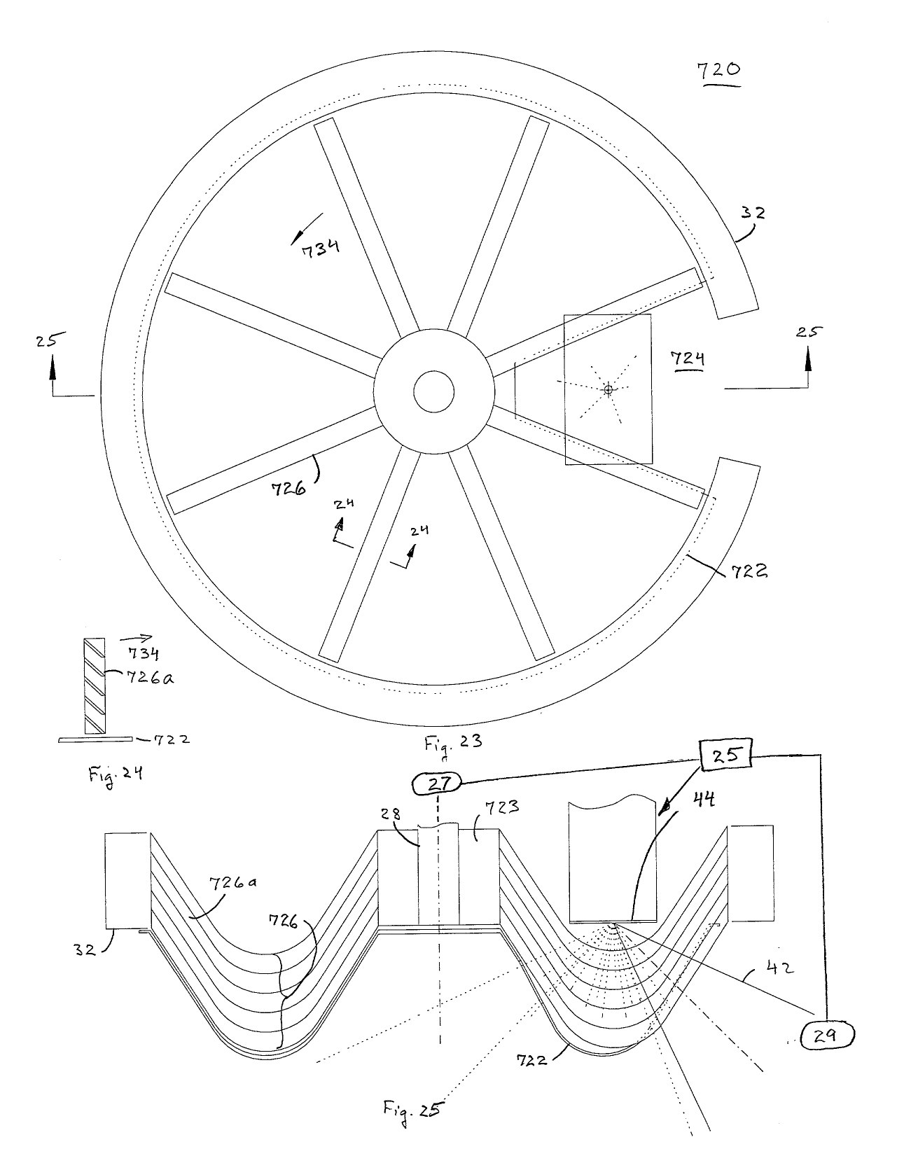

The circular array of vanes in the shutter is approximated by a linear array of blades 70, as shown in FIG. 8. For simplicity, each vane is modeled as a single blade 70. The transmission probability of a molecule, or debris particle, traveling from the upstream (target) to the downstream side of the vanes is characterized by the blade spacing s and chord b, as well as its angle α, and the ratio of blade speed to mean debris speed S. The transmission probability as a function of these parameters has been calculated using Monte Carlo simulations and is shown in FIG. 9 (FIG. 2 from Kruger and Shapiro). The transmission probability for debris traveling from the target side to the downstream side is represented by the parts of the curves with S<0. If the blade speed is approximately 100 m/sec or greater, |S|will typically be significantly greater than 1, so the transmission probability will typically be less than 10% for the ranges of parameters shown in FIG. 9. Relatively large values of s/b are needed to provide the large solid angles we are seeking, and the curves suggest that the transmission probabilities in that case will be higher. However, the transmission probabilities in FIG. 9 probably represent significant overestimates for the present application. The transmission probability was calculated assuming the blade length to be very large, so gas molecules would collide with the turbine blades until they emerged on either the upstream or downstream side of the turbine. However, any debris particles which travel inward or outward along a radius of the blade will soon either hit the central hub or escape into the collection manifold 32. Furthermore, the model does not include the possibility of the debris sticking to the blades, so again the transmission probability is probably overestimated. Finally, diffuse scattering from the blades was assumed in the calculation. This assumption will probably be valid only for the smaller debris particles, as mentioned earlier. Larger debris particles will scatter from the vanes in an approximately specular manner, and the vane geometry will then preferentially divert the particles away from the X-ray volume.

FIG. 10 shows the embodiment of FIGS. 5, 6 and 7 as a variation of the geometry of FIG. 8. The single-blade vane 70 shown in FIG. 8 is replaced with a multi-blade vane 77 in FIG. 10. In this embodiment, the chord b is approximated as the sum of the chords b′ of the individual blades 79 in a vane 77. This geometry provides a vane system as thick in the direction normal to the target plane as needed to collect the debris, but presenting a substantially smaller shadow to the radiation from the plasma. With this design, the solid angle for the x-rays is no longer directly dependent on the s/b ratio or the blade angle cc, so values of these quantities can be chosen to minimize the transmission probability. However, it is not clear from the theory if the transmission probability for this case can be obtained directly from FIG. 10 for the corresponding values of s/b and α. It may only represent a guide.

In order to reduce the transmission probability, a series of vanes can be interdigitated by a series of stator blades. The angular pitch of the stators is opposite that of the rotating blades. If the stator geometry is the same as that of the rotors, the stators will have approximately the same transmission probability as that of the rotors, and both theory and experiment show that for n planes of stator and rotor, each with transmission probability p, the total transmission probability for the array is approximately pⁿ. Thus, very low transmission probabilities can be obtained with a multistage shutter.

FIGS. 11-13 are plane and cross-sectional views along line 12-12 and 13-13, respectively of another embodiment of a shutter 320 of the present invention. The embodiment shown in FIG. 11-13 is similar to the embodiment shown in FIGS. 5-7 and is provided with additional stationary stator 327 having blades 327a. The stator blades 327a extend from a stationary wall of the shutter 328 or can extend from a wall of the manifold 32. The stator blades 327a intermesh with rotating blades 326a of vanes 326. As noted above, a multistage shutter with intermeshed rotating blades and stator blades is expected to provide excellent isolation between the target and downstream optical surfaces. For example, if the transmission probability for the debris across a blade is approximately p=0.1 then the transmission probability for the embodiment shown in FIGS. 11-13 (four rotors, 3 stators) might be approximately 10⁻⁷.

The stator blades 327a partially extend in a circumferential direction about axis of rotation 30. The stator blades 327a define an opening 324 to allow the passage of X-rays as well as the laser beams 42 therethrough. The stator blades 327a are oriented in a direction generally opposite to the direction of the rotating blades 326a relative to the plane of the shutter 320 and relative to the axis of rotation 30. The stator blades 326a, of course, increase the complexity of the shutter.

Any debris impacted by the blades 326a of the vanes 326 either coats the blades 326a, coats the stator blades 327a, is deflected by the blades 326a in a direction preferentially toward the target 44 (away from the plane defined by the plate 222) and/or radially outward toward the manifold 32, or is deflected by the stator blades 327a in a direction away from the target 44. With the orientation of the blades 326a shown in FIG. 10, the shutter 320 is preferably rotated in a direction 234 to achieve such deflection by the blades 326a and by the stator blades 327a. In another variation (not shown), the shutter may be extended radially relative to the axis of rotation to protect the laser beam generating system, and particularly the optical components of the laser generating system, from the debris. In this variation, the plate is extended radially and an additional set of circumferentially disposed openings may be provided through the plate. The first set of openings allows the X-rays to pass through the open shutter. The second set of openings allows the laser beam pulses to pass through the open shutter to the target. In the numerous variations of the shutter described above, it is to be understood that any variation of the shutter of the present invention can include or exclude any combination of those variations. For example, any or all of the embodiments may include a covering on a side of the plate opposite and/or same as the vanes, whether the covering is integral with, is supported by, or is completely independent of the manifold.

At the cost of added complication, the embodiments described here can be modified to provide greater solid angles. For example FIGS. 15, 16, and 17 show a version 520 of FIGS. 1-4 where two shutters with separate axes are combined to produce a larger aperture for x-rays than a single shutter alone could. The same or similar reference numbers are used to describe elements similar to those in the earlier embodiments. For example the top shutter in FIG. 15 (parts identified by suffix “a”) contains openings for the x-rays 24a, with vanes 26a attached to shutter plate 22a, which is attached to hub 28a and rotates in the direction 534a. The bottom shutter (parts identified by suffix “b”) is essentially identical in description. The two shutter plates rotate in opposite directions 534a and 534b. Note however that the vanes of the two shutters are disposed in different azimuthal orientations, relative to the openings 24a and 24b, on the two plates. Note also that the two shutter plates lie in proximate but different parallel planes, as shown in FIG. 16. As a result the two shutter planes can overlap slightly without collisions occurring between the shutter plates and the vanes of the two plates. For example it can be seen from FIG. 15 that vanes 26a′ and 26b′ will not collide as they rotate into the x-ray opening space 526. The control system 525 differs from control system 25 in that it must supply signals to two separate shutter motors 27a and 27b now.

A plate 539 covers the shutters on the side opposite that of the laser target, and is opaque save for an opening 526 where the x-rays emerge. The laser beam 42 is introduced from the side through cuts in plate 539 and manifold 532. The ellipse 550 shows the cross section of the laser beam in the plane of shutter plane 22a. The angular size of the laser beam is consistent with it being projected from an f/2 lens.

Although the opening in plate 539 is shown larger than the shutter opening, it may be better to make it slightly smaller, so it defines the solid angle rather than the shutter which may shift in angular phase during operation.

This embodiment will significantly increase the available solid angle. For example, if FIGS. 15 and 16 are interpreted as scale drawings, the solid angle for the x-rays is about 1.0 steradian.

An embodiment 620 based on the embodiment 320 is described in FIGS. 18, 19, 20, and 21. Basically two shutters similar to embodiment 320 are combined to approximately double the solid angle. The opening for the x-rays 626 is asymmetric, to allow access for the laser beam. For the same reason the stator blades do not have the same azimuthal period as the rotor blades. This is not expected to have any effect on performance. The two rotors rotate in opposite directions 634a and 634b. Because the two rotor assemblies are placed at different distances from the plane of the laser target 44, the blades from the two assemblies intermesh and don't collide with one another. A plate 622 covers the shutters on the side opposite that of the laser target, and is opaque save for an opening 626 where the x-rays emerge. Plate 622 is shown in FIG. 21. The location of the laser focal point 43 in the plane of the target 44 is indicated. The laser beam 42 is introduced from the side through cuts in plate 622, manifold 632 and stator mount 628. The ellipse 650 shows the cross section of the laser beam in the plane of plate 622. The angular size of the laser beam is consistent with it being projected from an f/2 lens.

Although the opening in plate 622 is shown larger than the opening defined by the rotors, it may be better to make it slightly smaller, so it defines the solid angle rather than the rotors which may shift in angular phase during operation.

This embodiment will significantly increase the available solid angle. For example, if FIGS. 18 and 20 are interpreted as scale drawings, the solid angle for the x-rays is about 1.8 steradian. If the embodiment 620 eliminated the stator blades, the distance between the laser target plane and the plane of plate 622 could be substantially reduced, thereby significantly increasing the solid angle.

Another embodiment 720 which can provide larger solid angles is described in FIGS. 23, 24, and 25. Instead of lying in planes parallel to the plane of the target 44, the rotor blades 726 as well as the stationary plate 722 are curved, with the source of the plasma radiation positioned approximately at the radii of curvature of the rotors and plate. This allows the manifold 32, as well as the shaft 28 and rotor hub 723 to be moved relative to the target plane, so that more unobstructed solid angle is available to the radiation.

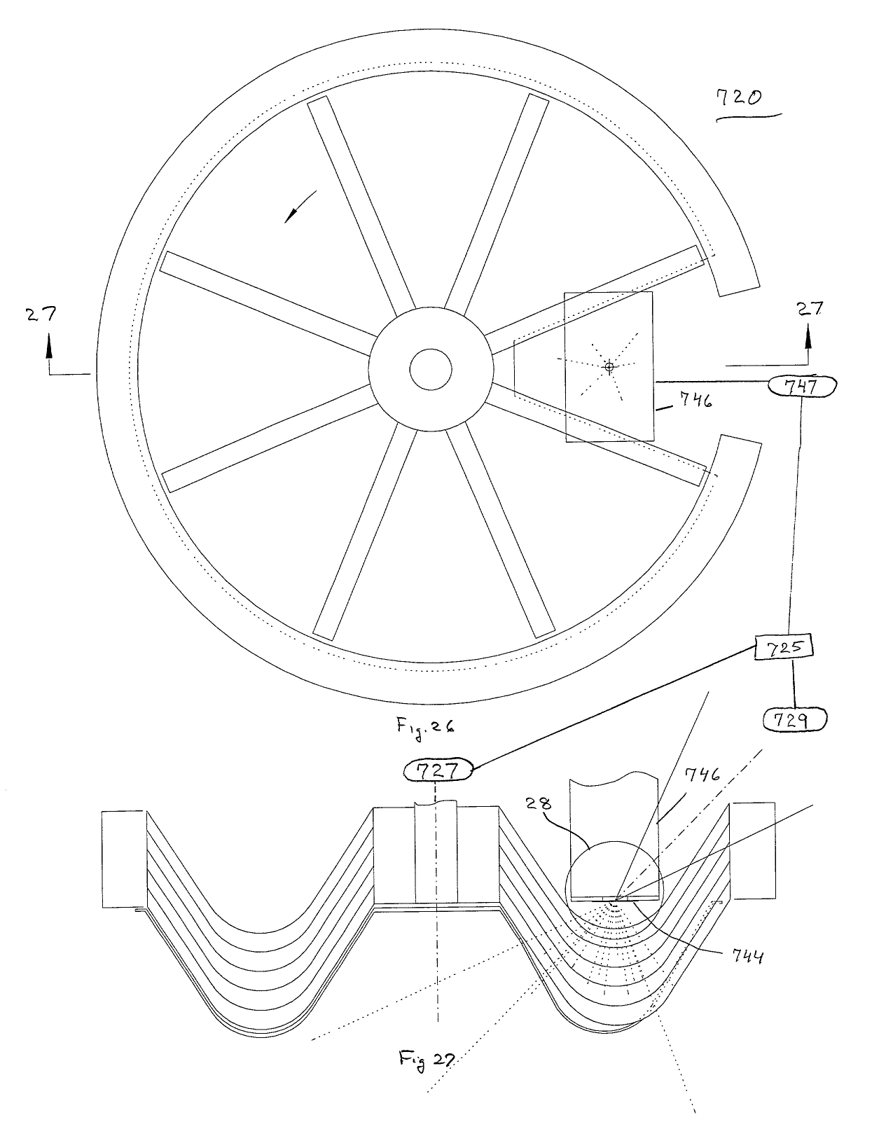

The relative orientation of the rotor blades 726 is shown in FIG. 24 and remains the same as in earlier embodiments. Therefore the blades are expected to possess a similar efficiency for debris removal.

Interpreting FIGS. 23 and 25 as scale drawings, the solid angle defined by the opening 724 in stationary plate 722 exceeds 3 steradian. This includes the solid angle subtended by the laser beam however. The plasma radiation emitted into this solid angle is unavailable for use, because condenser optics or exposure targets placed there would interfere with the laser light and related optics. Although laser targets are not part of this invention, some types of targets can permit repositioning of the laser beam, so that the full solid angle is available for the radiation. This is illustrated in FIGS. 26-30.

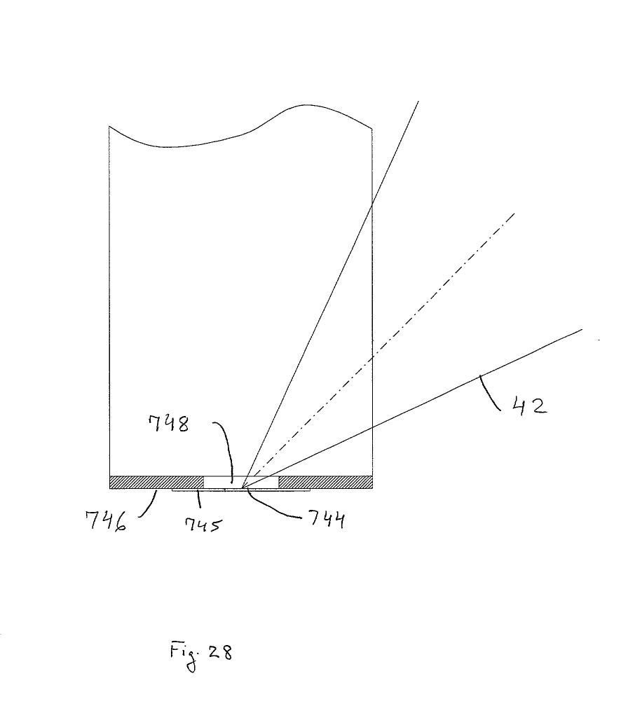

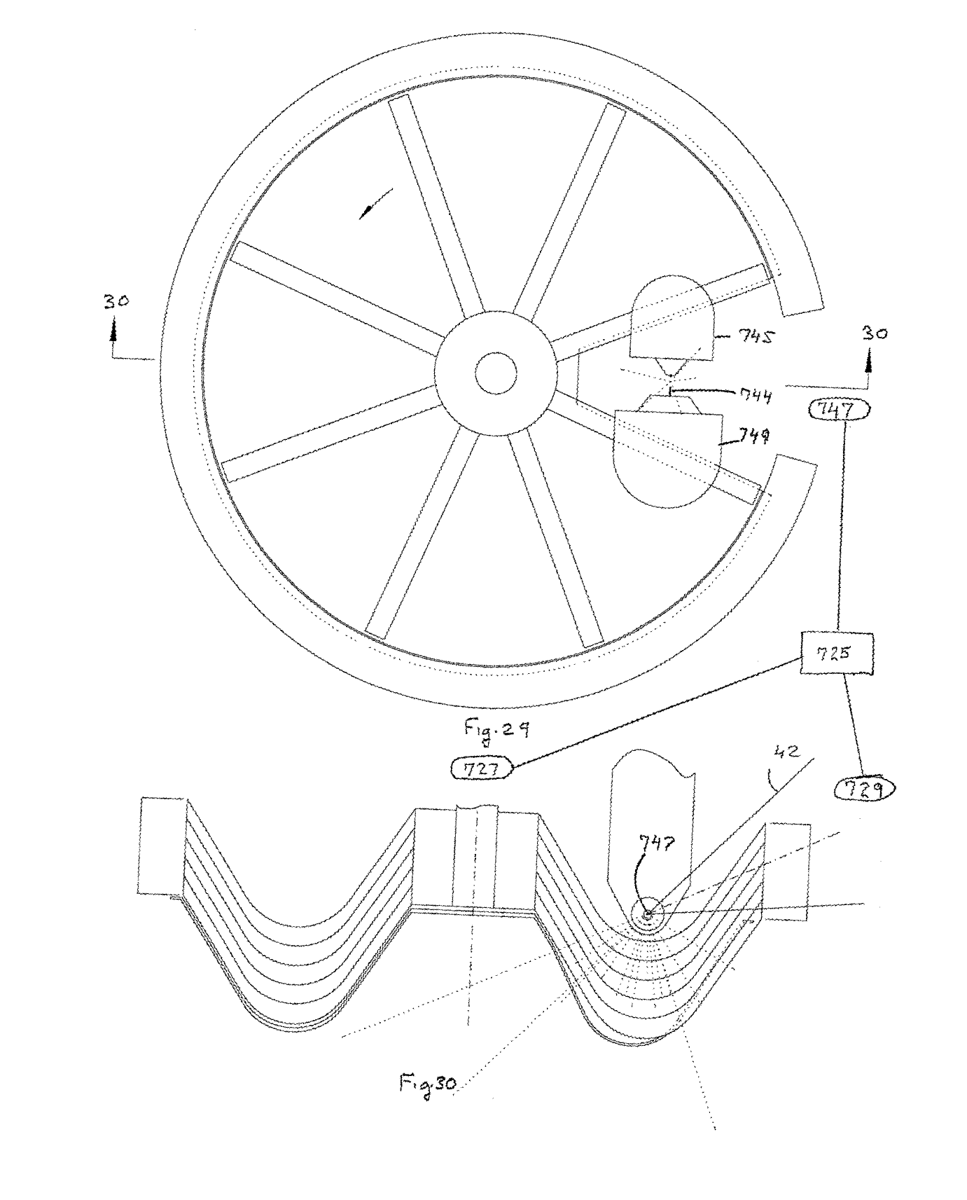

FIGS. 26-28 show the embodiment 720 used with a tape target in which the target material 744 is deposited on a thin tape 745 which is continuously moved out of the plane of FIG. 27 as parts of it are vaporized by the laser. An example of a tape target system is given by S. Haney et al., “Prototype high speed tape target transport for laser plasma soft x-ray projection lithography source” in Applied Optics, Volume 32, p. 6934 (1993). Some details of the target are shown in FIG. 28. The tape slides over a form 746 which has an opening 748 where the laser beam can be focused onto the back of the tape. The laser is positioned behind the tape relative to the stationary plate 722. The tape has very thin areas where the laser pulse is focused, so the plasma vaporizes the entire thickness of the tape. Radiation from the plasma is then approximately isotropic. The thin areas of the tape should be less than about 1 micron in thickness to ensure “burn through” of the tape by the laser plasma. If the target material has the appropriate physical properties, it could be attached as a self-supporting film to a tape with holes in it. In that case there would not be any radiation from tape material which would generally have different spectral properties than the target material. Also more of the laser energy would go into heating the plasma from the target material, increasing the radiation efficiency. A control system 725 controls the rotor 726 rotation, the laser beam pulse generator 729, and the tape target system 747.

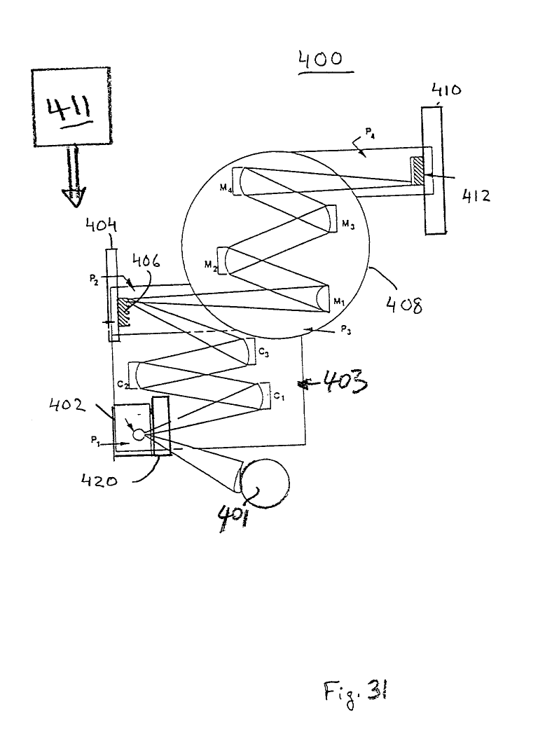

FIGS. 29 and 30 show the embodiment 720 with parts of a gas or liquid target. An example of a gas target is described in e.g., “Scale-up of a cluster jet laser plasma source for Extreme Ultraviolet Lithography,” by G. Kubiak et al. in Proceedings of SPIE, Volume 3676, p. 669 (1999). The gas or liquid 744 is emitted, either in pulses or as a steady stream, from a nozzle 747 in the source 745. After passing through the focus of the laser, the stream of any remaining fluid enters a collector 749 which removes it from the target area. This is essential if the region is to be maintained at a partial vacuum. Again the laser beam is positioned behind the target, so that the front of the target and shutter assembly is available for condenser optics or other uses.

As mentioned earlier in this patent, gas targets are expected to generate relatively little debris. However the gas density, and therefore the plasma radiation intensity, decrease with distance from the nozzle. To maximize radiation efficiency therefore the laser should be as close to the nozzle as possible. However, debris coming from erosion of the nozzle material by the plasma then becomes a problem. Including the embodiment 720 will thus allow the laser focus to be moved closer to the nozzle, increasing the radiation efficiency.

Other variations may be implemented within the scope of the invention and without deviation from the inventive aspects of the present invention. For examples, rather than providing a plurality of alternating openings and vanes on the plate of the shutter, a single opening and/or a single vane may be provided. Further, a mechanical shutter may be provided along with one or more vanes mounted on a rotatable shaft without a plate or with a plate having only arms overlapping with the vanes. The mechanical shutter is preferably controlled to open depending upon the rotation of the vanes and yet may be physically independent of the rotation of the vanes. In such an embodiment, the mechanical shutter replaces and serves a similar function as the openings provided on the plate.

It is noted that it is not essential that the shutter is driven to move in a periodic or cyclic manner. The shutter may be driven to move in a repetitive, non-periodic manner to accomplish the debris containment function of the present invention. Rather, it is important that the motion of the shutter should be synchronized with the plasma emitted radiation such that the pulses of emitted radiation is allowed to pass through the shutter, but the debris generated from the plasma is blocked by the shutter in the manner described above.

FIG. 31 is a simplified partial side view of an example of a lithography system 400 in which the debris containment shutter of the present invention may be utilized. The lithographic system 400 generally comprises an illumination system or radiation source 402 such as a laser plasma radiation generator working in conjunction with an optical laser beam 401, a system of condenser mirrors 403 to transfer the radiation to a reticle supported on a reticle stage 404, a system of mirrors 408 to project an image of the reticle onto a wafer, and a wafer handling system 410 for supporting and positioning a resist or photoresist covered wafer 412. The reticle 406, the lens system 408 and the wafer 412 are all positioned in the optical path of the radiation source 402 such that the radiation projected through the lens system 408 exposes the pattern of the reticle 406 (e.g., a circuit pattern for a semiconductor device) onto the wafer 412. The lithographic system 400 further comprises a frame (not shown) which supports the radiation source 402, the condenser mirror system 403, the reticle stage 404, the projection mirror system 408, and the wafer handling system 410.

The lithography system 400 further includes a debris containment shutter 420 of the present invention. The debris containment shutter 420 may be implemented as one of the embodiments described above. It should be understood that the lithography system 400 shown in FIG. 31 is merely illustrative and variations of the lithography system do not affect the applicability of the inventive method for controlling reticle temperature. A control system 411 controls the operations of the various components of the system lithography system 410, including the laser 401, radiation source 402, shutter 420, reticle 404 and wafer stage 410.

Although only a few exemplary embodiments of this invention have been described in detail above, those skilled in the art will readily appreciate that many modifications are possible in the exemplary embodiments without materially departing from the novel teachings and advantages of this invention. Thus, all matter contained in the above description and shown in the accompanying drawings shall be interpreted as illustrative and not limiting.

What is claimed is:

1. In a system for generating an electromagnetic radiation in which debris is generated with the generation of the electromagnetic radiation, a device for containment of the debris comprising a shutter structured and configured for sweeping a space in which the debris populates whereby the debris is removed from the space.

2. The device of claim 1 wherein the shutter comprises at least one member that is structured and configured for sweeping the space.

3. The device of claim 2 wherein the member is structured and configured for removing at least a portion of the debris from the space by collecting and/or deflecting the debris.

4. The device of claim 2 further comprising control means for controlling movement of the member to sweep the space in a repetitive manner.

5. The device of claim 2 further comprising control means for controlling movement of the member to sweep the space in a periodic manner.

6. The device of claim 5 wherein the member is structure and configured to make rotational movement about an axis, and wherein the control means controls the rotational movement of the member.

7. The device of claim 2 where in the control means is structured and configured to control the movement of the member in synchronization with the generation of the electromagnetic radiation.

8. The device of claim 2 wherein the shutter further comprises a barrier means for blocking at least a portion of the debris from the area but allowing passage of the electromagnetic radiation.

9. The device of claim 8 wherein the shutter is structured and configured to momentarily define an opening in the barrier to allow passage of the electromagnetic radiation through the shutter.

10. The device of claim 9 further comprising control means for controlling timing of the opening with respect to passage of the electromagnetic radiation.

11. The device as in claim 9 wherein the barrier means comprises a plate rotatable about an axis of rotation, said plate defining at least one opening to allow passage of the electromagnetic radiation.

12. The device as in claim 11 wherein the member is structured and configured to extend from a surface of the plate adjacent the opening, said member radially disposed relative to the axis of rotation.

13. The device as in claim 2 further comprising control means for controlling the rotation of the plate to synchronize positioning of the opening with respect to passage of the electromagnetic radiation.

14. The device of claim 13, wherein the shutter comprises a plurality of members and the plate defines a plurality of corresponding openings, said openings and members being circumferentially and alternately disposed about the axis of rotation.

15. The device of claim 2, wherein the shutter further comprises a manifold extending at least partially around said member and defining a volume for collection of debris from the space.

16. The device of claim 15, wherein said manifold is generally circular, said manifold defining at least one opening in a circumferential direction thereof.

17. The device of claim 15, wherein the shutter further comprises a plurality of members and said plate defines a plurality of corresponding openings, said opening in the manifold approximates the circumferential distance relative to the axis of rotation between two adjacent members.

18. The device of claim 12, wherein the shutter further comprises a cover extending at least partially across said plate at a distance from said plate and on a side of said plate opposite said member.

19. The device of claim 14, wherein said opening is of a shape selected from a group consisting of circle, ellipsoid, elongate ellipsoid and notch.

20. The device of claim 2, wherein said member extends linearly in a radial direction relative to the axis of rotation.

21. The device of claim 2, wherein said member extends curvilinearly in a radial direction relative to the axis of rotation.

22. The device of claim 21, wherein said curvilinear member has a concave surface extending from the plate surface, said concave surface generally faces a direction of rotation when said plate is rotated.

23. The device of claim 2, wherein said member comprises a plurality of vanes angled with respect to the direction of sweeping movement of the member.

24. The device of claim 23, wherein each of said vanes is angled in a manner to deflect the debris away from the structures intended to be protected from the debris as said member is rotated.

25. The device of claim 24, wherein the shutter further comprises a set of stationary vanes at least partially intermeshed with said vanes of said member.

26. The device of claim 25, wherein said stationary vanes are disposed at an angle relative to the direction of the sweeping movement of the member.

27. The device of claim 24, wherein each of the vanes is curved in a direction perpendicular to the direction of sweeping movement of the member.

28. The device of claim 27, wherein the electromagnetic radiation is generated at a source positioned approximately at the vanes' radii of curvature.

29. A device for containing debris generated from a radiation source, comprising:
a member structured and configured to sweep the debris from a space above the radiation source in which the debris populates; and
control means for synchronizing the movement of the member to the production of radiation from the radiation source.

30. The device as in claim 29, wherein the radiation source comprises a target that produces plasma generated radiation and debris upon focusing an incident radiation thereupon.

31. An electromagnetic radiation source comprising:
a target of the type which can be activated to produce an electromagnetic radiation, wherein debris is also produced with the electromagnetic radiation;
a member structured and configured to sweep the debris from a space above the target in which the debris populates; and
control means for synchronizing the movement of the member to the production of the electromagnetic radiation.

32. The electromagnetic radiation source as in claim 31, wherein the target is of the type that can be activated to produce a radiation emitting plasma.

33. An exposure system comprising:
a radiation source, said radiation source comprising:
a target of the type which can be activated to produce an electromagnetic radiation, wherein debris is also produced with the electromagnetic radiation,
a member structured and configured to sweep the debris from a space above the target in which the debris populates, and
control means for synchronizing the movement of the member to the production of the electromagnetic radiation;
an optical system for imaging a mask pattern onto an article;
a stage device for precise positioning of the article for imaging.

34. The exposure system of claim 33, wherein the article comprises a wafer.

35. A method of containing debris associated with a source radiation, comprising the steps of:
sweeping, using a moving member, the debris from a space above the target in which the debris populates; and
synchronizing the sweeping movement of the moving member to the production of the source radiation.
